(19) United States
(12) Patent Application Publication
(10) Pub. No.: US 2007/0102544 A1
(43) Pub. Date: May 10, 2007

(54) Apparatus Comprising a Heat Shield

(75) Inventor: Michael W. Crabtree, Katy, TX (US)

Correspondence Address: DEMONT & BREYER, LLC, 100 COMMONS WAY, HOLMDEL, NJ, 07733, US

(73) Assignee: CARGOMAX, INC., Katy, TX (US)

(21) Appl. No.: 11/556,980

(22) Filed: Nov. 6, 2006

Related U.S. Application Data
(60) Provisional application No. 60/733,351, filed on Nov. 4, 2005.

(51) Int. Cl. B05B 1/14; A62C 2/08

(52) U.S. Cl. 239/548; 239/558; 239/556

(57) ABSTRACT

A heat shielding system is disclosed. The system is suitable for use with burner booms, as are found on oil rigs and vessels. In some embodiments, the system includes two types of fluid nozzles that are disposed near the end of the burner boom. The first type of nozzle, which in some embodiments receives a flow of fresh water, generates a very fine mist that is primarily responsible for shielding the oil rig, etc., and associated personnel from heat that radiates from the flame exiting the burner. The second type of nozzle generates a spray of liquid that is primarily responsible for acting as a wind shield for the mist that is dispensed from the first type of nozzle.

### STATEMENT OF RELATED APPLICATIONS

This case claims priority of U.S. Provisional Patent Application Ser. No. 60/733,351 filed on Nov. 4, 2005 and incorporated by reference herein in its entirety.

### FIELD OF THE INVENTION

The present invention pertains to systems for shielding oil rigs and their personnel from the heat that is generated from flared hydrocarbons.

### BACKGROUND OF THE INVENTION

There are about 250 off-shore oil-well platforms in operation around the world today. Each of these wells is tested to determine well reservoir parameters and hydrocarbon properties. During well-test operations, hydrocarbons from the well are flowed to a well-test system that is located at the surface (e.g., either on the rig or on a testing vessel, etc.). The preferred way to dispose of these hydrocarbons is by flaring them. In particular, they are flared from a boom or pipe, known as a “burner boom,” that extends from the side of the rig.

This flaring operation results in very intense heat, typically in the range of 200 MW to 600 MW per second. The presence of such intense heat in the vicinity of the rig can compromise its structural integrity and create a dangerous working environment for rig personnel. This heat must therefore be dissipated.

One way to address this problem is by surface wetting the rig. This is done using conventional “deluge” systems. These systems deliver a large volume of salt water toward the rig. For example, a typical fluid pumping capacity of a deluge system that is designed for a 200 MW/s flame source is about 2500 gallons per minute. But as flaring temperatures increase due to improvements in burner technology, conventional deluge systems have proven to be inadequate to protect the rig and its personnel.

An improvement over the deluge system is a system that uses a “dual-discharge nozzles.” One such dual-discharge nozzle is disclosed in GB 2299281. The dual-discharge nozzle delivers a primary discharge comprising a strong conical spray of water. The nozzle also delivers, within the cone of the primary discharge, a secondary discharge comprising a mist of water. As described below, the primary discharge serves as a wind shield and the secondary discharge serves as a heat shield.

In this latter system, the dual-discharge nozzles are disposed on the burner boom. The nozzles deliver water, in particular sea water, close to the flare and, importantly, between the flare and the rig. The secondary discharge—the mist—absorbs the radiated heat, thereby limiting the transfer of radiated heat through the atmosphere and onto the rig. The primary discharge, which forms a conical-shape water spray, is stable in wind speeds up to about 27 miles per hour and functions as a wind shield for the heat-absorbing mist. The wind shield, at least for wind speeds below about 27 mph, prevents wind from dispersing the mist.

The system also uses a secondary set of nozzles, which are disposed along the side of the rig at appropriate locations to provide supplementary cooling.

The prior-art systems, while effective in terms of preventing significant fire damage, are expensive in terms of operating costs and maintenance requirements. In particular, aside from the cost of the equipment itself, which includes a large number of spray nozzles, large-diameter piping and large-capacity pumps, there is a substantial energy requirement to pump the large volume of water that is required. Furthermore, upon evaporation, any salt water that was sprayed onto the rig and its equipment leaves a brine coating that requires de-scaling and entails frequent re-painting of the structure and equipment.

### SUMMARY OF THE INVENTION

It is known that clouds protect the earth from the radiant heat of the sun. Clouds are made up of a dense layer of tiny water droplets that refract and reflect the sun's rays. The inventor has recognized that this concept can be employed to protect a facility, such as an oil-well rig, from the searing heat of test flames from a burner boom without some of the costs and disadvantages of the prior art.

A heat-shielding system in accordance with the illustrative embodiment of the present invention comprises a plurality of nozzles that are capable of producing a dense cloud of mist having exceedingly small water droplets. The dense mist cloud, which is projected between a heat source (e.g., flame emanating from a burner boom) and an object (e.g., rig, equipment, personnel, etc.) to be protected, provides at least two functions that are different from prior-art systems:
1. It diverts the heat, reflecting it away from the protected object.
2. If refracts heat, lengthening the radiation wavelength, thereby shifting the radiation to outside of the infrared spectrum. This greatly reduces the ability of such radiation to heat at a distance.

The mist cloud that is generated by a system in accordance with the illustrative embodiment of the present invention truly functions as a shield, diverting heat. Of course the mist cloud absorbs heat, but that effect is minor compared to its ability to (1) reflect heat away and (2) refract it to longer wavelengths. Due to the efficiency of the mist cloud at reflecting and refracting heat, a system in accordance with the illustrative embodiment will require only about 1/60 of the water of existing systems.

For the mist cloud to function effectively as a heat shield, reflecting and refracting, it must have a sufficiently high density of water droplets. As a practical matter, that means that the mist cloud must contain a “large-enough” quantity of “small-enough” water droplets. For heat shielding purposes, “small enough” means a mist having an average droplet size of less than about 150 microns and “large-enough” means delivering about twenty to thirty liters of water mist per minute per nozzle. The mist density and droplet size requirements are particularly important to create the refraction effect, and are a function of the coefficient of refraction of water.

In order to achieve the required mist density, the mist “cloud” should be kept relatively small. To facilitate this, the nozzles are situated near the flame-end of the burner boom.

In some embodiments, the system incorporates two types of fluid nozzles, which are disposed near the flame-end of the burner boom. Several nozzles of each type are typically present.

The first type of nozzle (hereinafter referred to as a “type-1 nozzle”) generates an ultra-fine mist of liquid, typically water, for heat shielding (i.e., diverting and refracting). As indicated above, the average droplet size of liquid in the mist is less than 150 microns.

A nozzle that is particularly well suited for producing a mist with a very small droplet size is a pneumo-acoustic nozzle that is disclosed in U.S. Pat. No. 7,080,793, which is incorporated by reference herein.

That nozzle is dual-fluid nozzle, which, for use in conjunction with the heat-shielding system disclosed herein, uses water (as one of the fluids) and compressed air or nitrogen (as the other fluid). The nozzle operates at low liquid pressures, typically 5 to 8 psi. The nozzle operates at a compressed air pressure of around 60 psi.

For use in conjunction with the illustrative embodiment, the mass ratio of water to compressed air for a dual-flow nozzle such as the one referenced above will typically be in a range between about 1:1 to 5:1. It is notable that the design that is disclosed in U.S. Pat. No. 7,080,793 might have to be modified if operation at a ratio closer to 5:1 is desired. The modification entails reducing the size of the gas outlet orifice of the nozzle.

The average size of the water droplets in the ultra-fine mist increases with an increase in the water-to-air mass ratio. For example, at a ratio of about 1:1 water-to-air, the average size of the water droplets in the ultra-fine mist is in the range of about 60 to 80 microns. At a ratio of about 5:1 water-to-air, the average size of the water droplets will be about 135 microns.

It is desirable, on the one hand, to reduce the requirement for gas (e.g., compressed air, etc.). Doing so suggests operating at relatively higher water-to-air ratios (i.e., closer to 5:1). But, as previously mentioned, the average size of the water droplets increases as the water-to-air ratio increases. And an increase in the droplet size of the mist is generally correlated with a decrease in its effectiveness as a heat shield. As a consequence, the operating water-to-air ratio of the dual-fluid nozzle will balance heat-shielding effectiveness versus the consumption of compressed air.

The second type of nozzle (hereinafter referred to as a “type-2 nozzle”) that is used in the heat-shielding system that is disclosed herein produces a spray for the purpose of wind shielding. Typically, this spray will have relatively larger droplets than that produced by the type-1 nozzle and usually deliver a greater quantity of water.

In some embodiments, the type-2 nozzles deliver water in a flat spray pattern, thereby creating “sheets” of water. The water is sprayed at an outward angle from the flare to encompass the ultra-fine mist from the type-1 nozzles. That is, the ultra-fine mist is between flare and the spray from the type-2 nozzles.

The intent of these sheets of water is to provide a barrier that prevents wind from dispersing or otherwise disrupting the ultra-fine mist from the type-1 nozzles. To reach the heat-shielding ultra-fine mist, the wind must deflect the sheets of water from the type-2 nozzles. This causes the wind to lose energy and, therefore, results in a decrease in wind speed. This reduces the potential impact of prevailing winds upon the ultra-fine heat-shielding mist from the type-1 nozzles.

In some embodiments, the type-2 nozzle operates with a single fluid—typically water—at about 100 psi and produces droplets having an average size greater than about 300 microns. A nozzle suitable for use in type-2 nozzle service is available from Spraying Systems, Co. of Wheaton, Ill.

In some other embodiments, a different type-2 nozzle is used for wind shielding. This other nozzle delivers mist in a conical spray pattern. The mist from this type of nozzle is directed more “into” the wind, as opposed to relatively orthogonal to it for the nozzle that delivers the flat spray pattern. This type-2 nozzle operates with a single fluid—typically water—at about 170 psi and produces droplets having an average size within the range of about 200 microns. This nozzle was developed by Andreyev Acoustic Institute in Moscow, Russia, and is available under license through Life Mist Technologies, Inc. of Paoli, Pa.

It is notable that to provide additional protection to the rig and its equipment, prior-art burner-boom cooling systems spray water directly on portions of the rig and captive equipment. Likewise, some embodiments of the heat-shielding system disclosed herein include secondary arrays of type-1 nozzles that deliver ultra-fine mist directly to the sides of the physical plant (e.g., rig, vessels, equipment, etc.). In the prior art, the rig and equipment is sprayed with seawater, which necessitates routine re-painting. By contrast, since water usage rates are so low through the type-1 nozzles of the system disclosed herein, fresh water can be used, such that repainting of the physical plant is not required.

A comparison of the dual-discharge, prior-art system with the heat-shielding systems disclosed reveals some similarities as well as some significant differences.

As to similarities, both the prior-art and the present systems utilize two types of water sprays for two different functions: one for heat shielding and the other for wind shielding.

As to differences, in the prior-art, the mist absorbs heat whereas in the present system, the mist refracts and reflects most of the heat that it receives. This distinction is due, as previously indicated, to a difference in the mists that are generated by the two different systems. In particular, in systems that are disclosed herein, the average droplet size of the mist is less than 150 microns and as small as about 60 microns as a function of the water-to-gas ratio. On the other hand, the average droplet size of mist that is generated by the dual-discharge nozzle disclosed in GB 2299281 is well in excess of 150 microns. The droplet size of the water in the mist must be less than about 150 microns to efficiently refract/reflect heat.

The mist generated by the present system is far more efficient at refracting/reflecting heat than the mist generated in the prior art system is at absorbing heat. Consequently, the present system uses far less water than prior art systems. In fact, when using a nozzle such as is disclosed in U.S. Pat. No. 7,080,793 for type-1 service in the systems disclosed herein, the water requirement is reduced to the extent that fresh water, as opposed to sea water, can be used for heat shielding. This lengthens maintenance intervals for re-painting the rig, etc., relative to prior art systems that use sea water. If desired, sea water can be used in conjunction with the nozzle that is disclosed in U.S. Pat. No. 7,080,793.

Another difference between the prior-art and the systems disclosed herein relates to nozzle functionality. Specifically, in the prior art, two functions—heat shielding and wind shielding—are provided by the dual-discharge nozzle disclosed in GB2299281. In systems in accordance with the illustrative embodiment of the present invention, these functions are decoupled. That is, heat shielding is relegated to type-1 nozzles and wind shielding is the province of type-2 nozzles.

Segregating heat-shielding and wind-shielding to two different types of nozzles enables selected use of the wind-shielding nozzles, as conditions permit. That is, depending upon wind direction, it might be desirable to use only some of the wind-shielding (type-2) nozzles. Or the pressure (i.e., flow rate) can be increased through selected nozzles to account for wind direction, wind speed, or both. Or, in the absence of wind, there is a possibility that none of the wind-shielding nozzles will be activated. In any of these scenarios, by virtue of the fact that there is an ability to selectively activate the wind-shielding nozzles and selectively control the flow of water through them, water is used more efficiently than would otherwise be the case.

Additionally, due to the substantial decrease in overall water usage for the system disclosed herein, smaller capacity pumps and piping is used in the illustrative embodiment. This equates to a significant savings in equipment cost.

### BRIEF DESCRIPTION OF THE DRAWINGS

FIG. 1 depicts a side view of a heat-shielding system in accordance with the illustrative embodiment of the present invention.

FIG. 2 depicts a flame-end view of the heat shielding system of FIG. 1.

FIG. 3 depicts a flame-end view of an alternative embodiment of the heat shielding system of FIG. 1.

### DETAILED DESCRIPTION

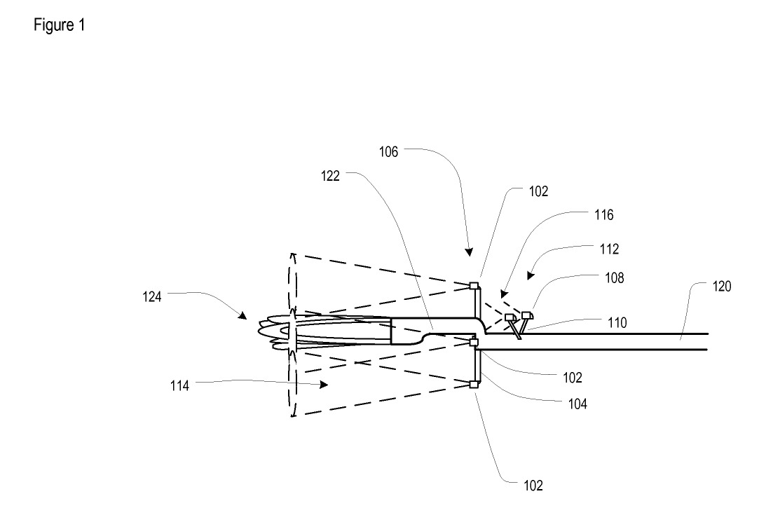

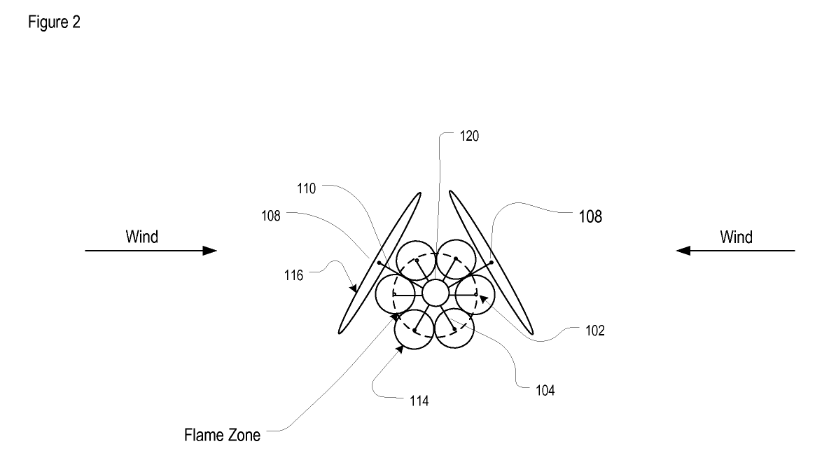

FIG. 1 depicts a side view of primary heat-shielding system 100 in accordance with the illustrative embodiment of the present invention. FIG. 2 depicts a “flame-end” view of system 100 of FIG. 1. In the illustrative embodiment, system 100 is used in conjunction with a “burner boom,” such as is used on oil rigs and floating oil platforms during well-test operations.

As depicted in FIGS. 1 and 2, primary heat-shielding system 100 includes a first grouping 106 of type-1 nozzles 102 and a second grouping 112 of type-2 nozzles 108. In the illustrative embodiment, type-1 nozzles 102 are disposed on the end of individual supports arms 104 and type-2 nozzles 108 are disposed on the end of individual supports arms 110. The supports for both types of nozzles extend radially from boom 120. As depicted most clearly in FIG. 2, for this embodiment, there are six type-1 nozzles 102 and two type-2 nozzles 108. It will be understood that the number of nozzles (and the capacity thereof) depends upon the thermal content of the hydrocarbons being combusted. This varies greatly and is directly proportional to the flow rate and BTU content of the hydrocarbons.

Type-1 nozzles 102 project an ultra-fine mist of liquid 114 (e.g., water, etc.), around flare or flame 124 that emanates from burner 122 at the end of boom 120. The conical spray pattern from type-1 nozzles 102 creates a shield that refracts/reflects some portion of the flame's heat from radiating to the rig, equipment, and personnel.

In some embodiments, type-2 nozzles 108, which are disposed radially outward of type-1 nozzles 102, deliver a relatively flat spray pattern (see FIG. 2) of water 116 on either side of flame 124. The “sheets” of water 116 formed by type-2 nozzles 108 are intended to act as a wind shield to prevent wind from disrupting heat-shielding ultra-fine mist 114 that is generated by type-1 nozzles 102. In some other embodiments (not depicted), type-2 nozzles 108 deliver a conical spray pattern of water of either side of flame 124.

As a function of local weather conditions (e.g., wind, etc.), either both, one, or neither of type-2 nozzles 108 are activated. For example, if the wind is blowing from the “left” in FIG. 2, then it might be acceptable to activate the one type-2 nozzle 108 that will block the wind coming from that direction, but not activate the other type-2 nozzle. Alternatively, the quantity of water issuing from type-2 nozzles 108 can be adjusted as a function of wind speed and direction.

Type-1 nozzles 102 and type-2 nozzles 108 are connected to appropriate utilities. For example, in some embodiments, type-1 nozzles 102 are connected to a supply of fresh water and compressed air or nitrogen, and type-2 nozzles 108 are connected to a supply of sea water. In some other embodiments, type-1 nozzles 102 are connected to a supply of sea water.

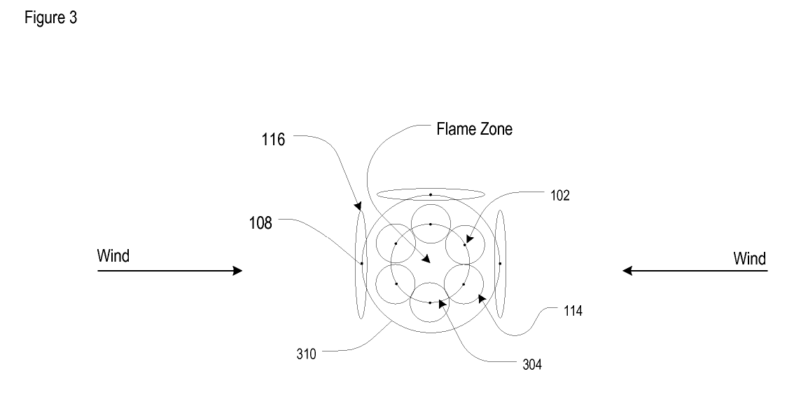

FIG. 3 depicts an alternative embodiment of the heat-shielding system, wherein type-1 nozzles 102 are supported by first ring 304 and type-2 nozzles 108 are supported by second ring 310. The rings 304 and 310 are coupled to the boom by support arms (not depicted). A third type-2 nozzle 108 is depicted in the embodiment that is shown in FIG. 3.

It will be appreciated that any of a variety of different arrangements for configuring type-1 nozzles 102 and type-2 nozzles 108 around the burner end of boom 120 can suitably be used. Those skilled in the art will be able to design and implement such arrangements in view of the present teachings. Also, it is to be understood that in some other embodiments, a greater number or a lesser number of type-1 nozzles 102 or type-2 nozzles 108 (or both types of nozzles) are used.

In some embodiments, as a function of the heat output from the flame 124, heat-shielding system 100 includes a secondary system (not depicted) of nozzles. The secondary system of nozzles is arranged to spray water directly on portions of the rig and its equipment. Type-1 nozzles 102 or type-2 nozzles 108 or both types of nozzles are used for this purpose. It is desirable, but not necessary, to use fresh water rather than sea water when spraying water directly onto the rig and equipment.

As previously indicated, the thermal content of the hydrocarbons being burned at the burner boom varies greatly. As a consequence, it would be advantageous to deploy a greater or lesser number of nozzles, as needed. This is facilitated using a modular approach, wherein each nozzle is independently controlled and supplied.

For example, in some embodiments, a “portable nozzle unit” includes a type-1nozzle. The nozzle is supplied by:
(1) A gas/vapor supply hose that couples, via a quick-connect coupling, to a shut-off valve. A hose leads from the shut-off valve to the vapor/gas inlet of the nozzle.
(2) A liquid supply hose that couples, via a quick-connect coupling, to a shut-off valve. A hose leads from the shut-off valve to a water pressure regulator, a water pressure gague, and then to the liquid inlet of the nozzle.

Analysis of the thermal requirements of heat-shielding system 100 is now provided. Table I below provides the energy density from a flame at radii from the flame (i.e., 30 meters and 50 meters) as a function of the amount of the heat that is radiant. These numbers are based on a likely maximum thermal output to be encountered.

TABLE I
Energy Density at 30 m and 50 m Radii as a
Function Of Infrared Radiation Percentage

| PERCENTAGE OF | AT A RADIUS | AT A RADIUS |
|---|---|---|
| ENERGY | OF | OF |
| PRODUCED AS | 30 METERS | 50 METERS |
| INFRARED RADIATION | <JOULES/M²> | <JOULES/M²> |
| 100 | 5.32 × 10⁴ | 1.90 × 10² |
| 90 | 4.79 × 10⁴ | 1.71 × 10² |
| 80 | 4.26 × 10⁴ | 1.52 × 10² |
| 70 | 3.72 × 10⁴ | 1.33 × 10² |
| 60 | 3.19 × 10⁴ | 1.14 × 10² |
| 50 | 2.66 × 10⁴ | 0.95 × 10² |
| 40 | 2.13 × 10⁴ | 0.76 × 10² |
| 30 | 1.60 × 10⁴ | 0.57 × 10² |

The heat transfer coefficient of the vessel on which the burner boom resides is a function of the reflectivity of the vessel's coating (e.g., paint) as well as the steel structural arrangement. Heat that is absorbed by the bulkhead radiates within the vessel interior as well as to the exterior. An important factor in terms of cooling requirements is how quickly the bulkhead can dissipate, by radiation and convection, the energy absorbed from the flame's infrared radiation.

To the extent that the energy density exceeds the physical plant's heat transfer rate for a zone or area of the vessel, protection from infrared radiant energy is required. Within a zone that requires protection, some areas must be protected by the dense ultra-fine mist from primary heat-shielding system 100. Some other areas within the zone might be able to be protected using only the secondary system of nozzles (wherein water is sprayed directly on portions of the rig and its equipment. There are still some further areas that are subject to the maximum thermal output and will require protection from primary heat-shielding system 100 as well as the secondary system.

The primary system 100 need not be designed to absorb all infrared radiant energy. Rather, it is advantageously designed to reduce the energy density in specific areas to levels at which the secondary system can provide the requisite heat dissipation. Using this approach, the water flow rate through type-1 nozzles can be reduced. As previously indicated, in some embodiments, the secondary system nozzles for generating both smaller and larger droplets of water. The nozzles that generate larger droplets would be used, typically, to spray a continuous mist on the physical plant.

Primary heat-shielding system 100 should be designed so that the surface of the physical plant can be cooled by surface evaporation of water at a rate that approaches zero net energy absorption. In other words, the basic design approach is to use the primary heat-shielding system 100 with its dense ultra-fine mist to reduce the amount of energy to dissipated by the surface of the rig, etc., such that surface evaporation will be sufficient to dissipate the remainder of the heat.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

Furthermore, it is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments.

What is claimed:

1. An apparatus comprising a first plurality of nozzles for producing a mist of liquid, wherein:
said nozzles are disposed near an end of a boom and proximal to a burner, wherein, during operation of said burner, flames issue therefrom;
said nozzles are arrayed around said burner such that said mist exiting said nozzles occupies a region between said flames and an object to be protected from heat from said flames; and
an average droplet size of liquid that composes said mist is about 150 microns or less.

2. The apparatus of claim 1 further comprising:
a second plurality of nozzles for producing a spray of liquid having a larger average droplet size than said mist, wherein said nozzles for producing said spray are disposed proximal to said burner and directed outward of said mist; and
a device for individually controlling flow through said nozzles that produce said spray.

3. The apparatus of claim 2 wherein said device controls pressure.

4. The apparatus of claim 1 wherein said mist comprises droplets having an average droplet size of less than about 100 microns.

5. The apparatus of claim 1 wherein said nozzles are dual-fluid nozzles, wherein water and a gas or vapor are fed to said nozzles.

6. The apparatus of claim 5 wherein a mass ratio of water to gas or vapor fed to said nozzles is in a range of about 1:1 to about 5:1.

7. The apparatus of claim 1 further comprising a source of fresh water, wherein said source of fresh water is fluidically coupled to said nozzles.

8. The apparatus of claim 1 wherein said nozzle is a pneumo-acoustic nozzle.

9. An apparatus comprising:
a first plurality of first nozzles, wherein said first plurality of said first nozzles are disposed near an end of a boom and proximal to a burner, and wherein said first nozzles produce a mist of water having a first average droplet size; and
a second plurality of a second nozzles, wherein said second plurality of said second nozzles are disposed near an end of boom and proximal to a burner, and wherein said second nozzles produce a spray of water having a second average droplet size;
wherein said first average droplet size is less than about 150 microns and is smaller than said second average droplet size.

10. The apparatus of claim 9 wherein said first average droplet size is less than about 100 microns.

11. The apparatus of claim 9 wherein said first nozzles receive a flow of water and a gas or vapor.

12. The apparatus of claim 9 wherein said first nozzles receive a flow of fresh water.

13. A method comprising:
deploying a mist near a source of heat, wherein an average droplet diameter of said mist is less than about 150 microns; and
deploying a spray near said mist, wherein said spray has an average droplet diameter that is greater than about 150 microns.
